(19) United States
(12) Patent Application Publication
(10) Pub. No.: US 2025/0102822 A1
(43) Pub. Date: Mar. 27, 2025

(54) BLUR REDUCTION TECHNIQUES FOR SEMICONDUCTOR INSPECTION

(71) Applicant: Onto Innovation Inc., Wilmington, MA (US)

(72) Inventors: Jian Ding, Methuen, MA (US); Ju Jin, Edina, MN (US)

(21) Appl. No.: 18/475,684

(22) Filed: Sep. 27, 2023

(51) Int. Cl. G02B 27/64; G01N 21/95; G02B 3/14; G02B 21/26; G02B 21/36; G02B 26/08

(52) U.S. Cl. CPC G02B 27/646; G01N 21/9501; G02B 3/14; G02B 21/26; G02B 21/361; G02B 26/0858

(57) ABSTRACT

Disclosed herein are techniques to reduce blurring in images taken during semiconductor inspection. A stage, which holds a substrate for inspection, can move at a substantially constant speed during inspection to increase throughput. In some techniques, a mirror system can be added to the camera system for reducing blur in images. The mirror system can include a rotating or dithering mirror to translate the linear motion of the stage into a counter rotational motion in the form of deflecting beam angles thereby reducing the motion blur caused by the movement of the stage.

### TECHNICAL FIELD

The present disclosure generally relates to imaging systems, in particular optical systems used for reducing blur in capturing images of a moving object.

### BACKGROUND

Sometimes it is desired to capture an image of a moving object. This can happen in manufacturing. In manufacturing objects, the faster you can move something the faster the throughput can be. In manufacturing semiconductors, the ability to process substrates, which can hold integrated circuits or other components, faster allows for more productivity. There is value in being able to process more substrates per unit of time. Some equipment in a semiconductor or similar manufacturing facility, need to capture images of the substrate for measuring, characterizing, or inspecting the substrate.

A problem that arises when trying to capture an image of a moving object at a certain speed is that motion blur occurs. Motion blur causes the image to be less sharp and more difficult to capture small features in the image. Some techniques to address motion blur can limit throughput. For example, some techniques use a strobe light to selectively illuminate the substrate that is moving during exposure by the camera system. However, the pulse speed of the strobe lights can be limited by the physical specifications of the light bulb and how long the light bulb needs to cool down between pulses.

### SUMMARY

Disclosed herein are techniques to reduce motion blur (“blur”) in images captured of a moving object. In semiconductor inspection systems, typically a substrate is inspected by moving it across camera. At a certain point, the substrate is moving so fast that an image capture system has blur. In some techniques, a camera can also be configured to move so that the mismatch between the speed of the camera the stage is reduced during image capture thereby reducing motion blur. The camera can be accelerated and deaccelerated to position the camera over different portions of the substrate to capture images of the different portions of the substrate. This can be performed in a predefined pattern.

In some techniques, a mirror system can be added to the camera system to reduce blur in the images. The mirror system can include a rotating or dithering mirror. This mirror system can translate the linear motion of the stage into a counter rotational motion that allows the imaging system to capture images of a substrate with reduced blur. This is because the motion of mirror system reduces the relative motion between the moving object being imaged and the imaging system.

This disclosure describes image capture system to reduce motion blurring during semiconductor inspection. The image capture system includes a stage to hold a substrate for inspection, wherein the stage is configured to move at a substantially constant speed during inspection; a microscope objective positioned opposite the stage; a mirror system to receive light beams from the microscope objective representative of the substrate and reflect the light beams to a tube lens, the mirror system including a mirror configured to move according to a preset angular velocity profile based on the speed of the stage, wherein the mirror system to move at a specified angular velocity for a defined time interval; and an image sensor to generate an image of a portion of the substrate based on light beams received from the tube lens during the defined time interval.

This disclosure also describes a method for inspection of a substrate. The method includes loading the substrate on a stage of an inspection system; moving the stage at a substantially constant speed; positioning the stage opposite a microscope objective; moving a mirror to reflect light beams from the microscope objective representative of the substrate to a tube lens, the mirror moving according to a preset angular velocity profile based on the speed of the stage, wherein mirror moves at a specified angular velocity for a defined time interval; and generating an image of a portion of the substrate based on light beams received from the tube lens during the defined time interval.

This disclosure further describes a system including a microscope objective positioned opposite a stage holding a substrate for inspection, wherein the stage is configured to move at a substantially constant speed during inspection. The system includes a tube lens and a mirror system positioned between the microscope objective and the tube lens, the mirror system to receive light beams from the microscope objective representative of the substrate and reflect the light beams to a tube lens. The mirror system includes a first mirror to move according to a preset angular velocity profile based on the speed of the stage, wherein the first mirror to move at a specified angular velocity for a defined time interval, and a second mirror positioned opposite the first mirror in a stationary orientation. The system further includes a camera to generate an image of a portion of the substrate based on light beams received from the tube lens during the defined time interval.

### BRIEF DESCRIPTION OF THE DRAWINGS

Various ones of the appended drawings merely illustrate example embodiments of the present disclosure and should not be considered as limiting its scope.

FIG. 1 illustrates example portions of an inspection system performing stop-and-go inspection.

FIG. 2 illustrates example portions of an inspection system performing inspection with a moving camera system.

FIG. 3 is a flow diagram a flow diagram for a method 300 for semiconductor inspection using a moving camera to reduce blurring.

FIGS. 4A-4C show beam deflections in an image capture system with stage movement.

FIG. 5 illustrates example portions of an image capture system with an optical system to reduce motion blur.

FIG. 6 illustrates an example of an angular velocity profile for a rotating mirror.

FIG. 7 illustrates an example of an angular velocity profile for a dithering mirror.

FIG. 8 illustrates an example of a motion profile for a dithering mirror.

FIG. 9A illustrates an example of a mirror system.

FIG. 9B illustrates example portions of the mirror system.

FIG. 10 illustrates a block diagram of an example comprising a machine upon which any one or more of the techniques (e.g., methodologies) discussed herein may be performed.

### DETAILED DESCRIPTION

Techniques to reduce motion blur (“blur”) in images captured of a moving object are disclosed. In semiconductor inspection systems, typically a substrate (e.g., semiconductor product) is inspected by moving it across camera. In other manufacturing setups, other moving systems may be used such a conveyer belt, a moving system, or a robotic system. At a certain point, the object or substrate is moving so fast that an image capture system has blur. In some techniques, a camera can also be configured to move so that the mismatch between the speed of the camera the stage is reduced during image capture thereby reducing motion blur. The camera can be accelerated and deaccelerated to position the camera over different portions of the substrate to capture images of the different portions of the substrate. This can be performed in a predefined pattern.

In some techniques, a mirror system can be added to the camera system to reduce blur in the images. The mirror system can include a rotating or dithering mirror. This mirror system can translate the linear motion of the moving system or stage into a counter rotational motion that allows the imaging system to capture images of an object or substrate with reduced blur. This is because the motion of mirror system reduces the relative motion between the moving object being imaged and the image capture system.

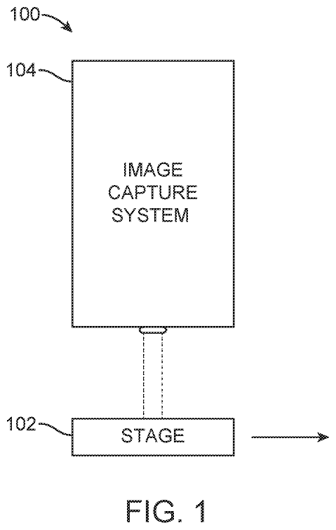

FIG. 1 illustrates example portions of an image capture system performing stop-and-go image capture. The image capture system can be in an inspection system 100 that may include a stage 102 and an image capture system 104. The stage 102 may be provided opposite the image capture system 104 and may carry one or more substrates for inspection. The stage 102 may include a granite structure and a chuck to hold the substrates. The stage 102 may be movable in the x, y, z, and θ directions.

The image capture system 104 may include a microscope objective, a tube lens, and a camera. The camera may be provided as an image sensor, such as a CMOS or CCD sensor. In some examples, the camera may be provided as an infrared sensor, such as InGaAs sensor. The camera may be coupled to a processor including an image analysis module. The processor may process the images generated by the camera and analyze the images to detect defects. The processor can do this by running at least one algorithm that compares a reference image to the captured image. The processor may execute machine learning algorithms to detect defects in the images captured by the camera of portions of the substrate.

In the example of FIG. 1, the image capture system 104 is kept stationary as the stage moves so that different portions of the substrate are positioned below the image capture system 104 at different times, and the image capture system 104 can capture images of the different portions of the substrate for inspection. The images may be compared to stored template images to detect defects in the substrate.

The stage 102 can move in a serpentine pattern so that the image capture system 104 can capture images of different portions of the substrate. As mentioned above, the movement of the stage 102 while the image capture system 104 is capturing images (i.e., exposure time) can cause motion blur in the images. To reduce motion blur, the stage 102 may move in a stop-and-go fashion. That is, the stage 102 may stop its movement when the portion of the substrate to be imaged is positioned below the image capture system. After the image is captured, the stage 102 may move so that the next portion of the substrate to be imaged is positioned below the image capture system and the image of the next portion is captured. The amount of time the stage 102 stops for each image capture may be equal to or greater than the exposure time of the image capture system 104.

The stage 102 may continue this stop-and-go operation in a serpentine or other specified pattern until the different portions of the substrate are imaged. However, the stage 102 can be large mass (e.g., ˜150 pounds). Accelerating and deaccelerating a heavy structure such as the stage 102 in a stop-and-go fashion may have drawbacks such as causing vibrations, reducing throughput, etc.

Other techniques for reducing motion blur are described next. For example, the image capture system can move at substantially the same speed as the stage during camera exposure to reduce motion blur.

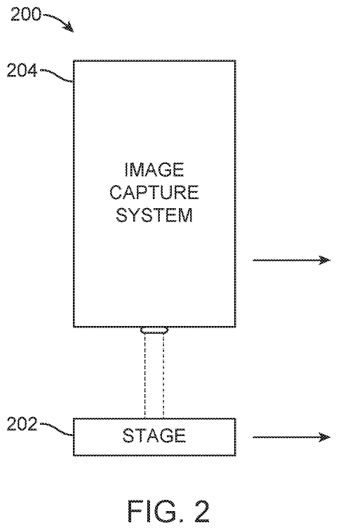

FIG. 2 illustrates example portions of an inspection system 200 performing inspection with a moving camera system. The inspection system 200 may include a stage 202 and an image capture system 204. The stage 202 may be provided opposite the image capture system 205 and may carry one or more substrates for inspection. The stage 202 may include a granite structure and a chuck to hold the substrates. The stage 202 may be movable in the x, y, z, and θ directions. For example, the stage 202 may be moving at a speed greater than 20 mm/sec. In some examples the stage 202 may be moving at about 200 mm/sec.

In this example, the image capture system 204 may be coupled to an actuator to move the image capture system in the x, y directions. The image capture system 204 may travel at substantially the same speed as the stage 202 when capturing an image of a portion of the substrate so that from the camera perspective, the stage appears to be substantially still and therefore can reduce image blurring. The image capture system 204 may then be moved so that it is positioned above the next portion of the substrate to be imaged and the velocity of the image capture system 204 may then be controlled so that substantially matches the speed of the stage 202 again to capture the image of the respective portion with reduced blurring. The stage 202 may move at a substantially constant speed during the inspection process, reducing vibrations and increasing throughput.

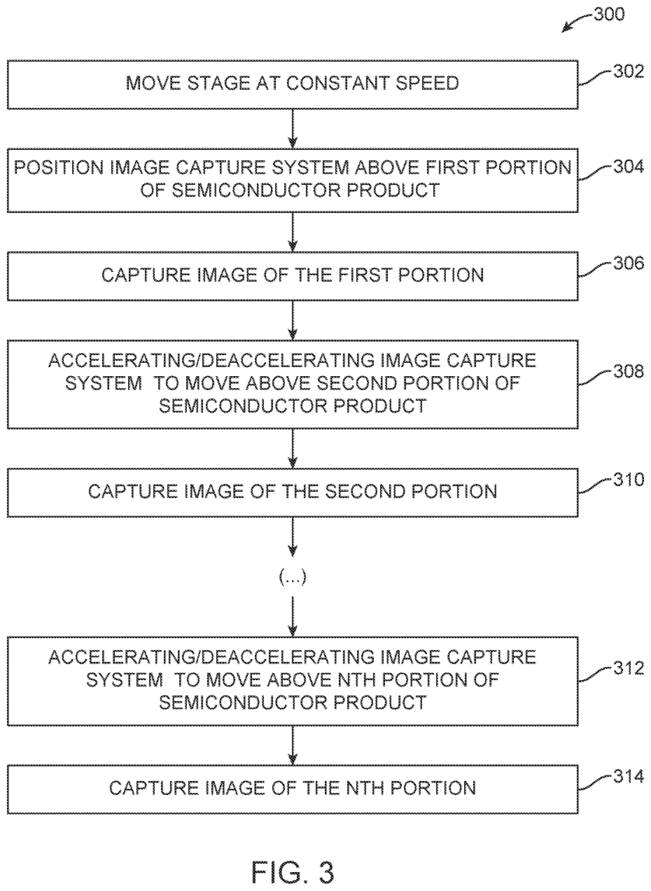

FIG. 3 is a flow diagram a flow diagram for a method 300 for semiconductor inspection using a moving camera to reduce blurring. For example, the method can be performed using the inspection system 200 as described above with reference to FIG. 2.

At operation 302, the stage carrying the substrate to be inspected may be moving at a substantially constant speed. For example, the stage may be moving at a speed greater than 20 mm/sec. In some examples the stage may be moving at about 200 mm/sec. At operation 304, the image capture system may be positioned above a first portion of the substrate to be imaged, and the image capture system may be moving at substantially the same speed as the stage. At operation 306, an image of the first portion of the substrate may be captured. Because the stage and image capture system are travelling at substantially the same speed, motion blurring in the image may be reduced.

At operation 308, the image capture system may be moved so that it is positioned above the second portion of the substrate to be imaged while the stage remains moving at its substantially constant speed. For example, the image capture system may be accelerated to move the image capture system forward so that the image capture system is positioned above the second portion and then deaccelerated to match the speed of the stage. In another example, the image capture system may be deaccelerated to move the image capture system backwards as compared to the stage so that it is positioned above the second portion and then accelerated to match the speed of the stage. At operation 310, an image of the second portion of the substrate may be captured. Because the stage and image capture system are travelling at substantially the same speed, motion blurring in the image may be reduced.

These steps may be repeated until the last portion (nth portion) of the substrate is imaged. In some examples, the stage and/or image capture system may move in a serpentine or other specified pattern to image different portions of the substrate. At operation 312, the image capture system may be moved so that it is positioned above the nth portion of the substrate to be imaged while the stage remains moving at its substantially constant speed. At operation 314, an image of the nth portion of the substrate may be captured. Because the stage and image capture system are travelling at substantially the same speed, motion blurring in the image may be reduced. The image capture system may weigh about 5-20 pounds so significantly less than the stage (e.g., ˜150 pounds); therefore, vibrations caused by the acceleration and deacceleration of image capture system may be significantly less than caused by the stage moving in a stop-and-go fashion as described above.

Blurring can also be addressed using an optical system in the image capture system to account for the stage movement. Linear motion in the stage space can be translated to linear motion in the camera space factoring in the magnification of the image capture system. For example, if the stage is moving at velocity v and the magnification of the image capture system is 10×, then the target in the camera space can be considered to be moving at 10v (magnification times the velocity of the stage). The movement of the stage relative to an image capture system may also be defined by rotational motion in the form of deflecting beam angles between components in the image capture system.

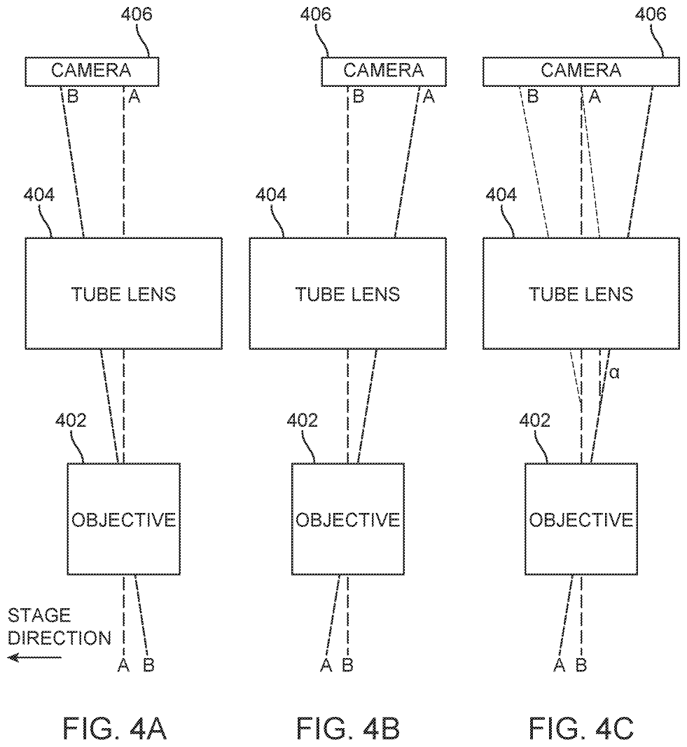

FIGS. 4A-4C show beam deflections in an image capture system with stage movement. The image capture system may include an objective 402, a tube lens 404, and a camera 406 (e.g., image sensor). FIGS. 4A-4C show the deflection of beams between the objective 402 and the tube lens 404. As shown, the stage is moving in a linear direction (from right to left), which causes the beam deflection between the objective 402 and tube leans 404. The linear shift between beams A and B can be defined by a rotational angle α. Thus, a deflection in the beam angle by a can reduce or eliminate the motion blur caused by the stage movement. Accordingly, for a stage with moving velocity v, a corresponding angular velocity ω of the deflection can compensate the motion blur, which can be represented as:

$$ω = v / f$$

where f is the focal length of the objective 402.

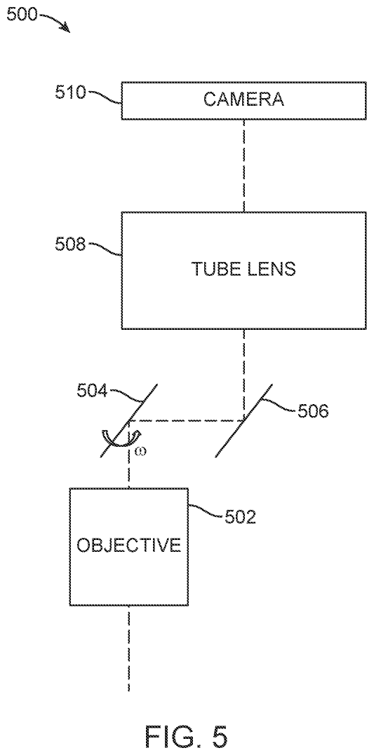

FIG. 5 illustrates example portions of an image capture system 500 with an optical system to reduce motion blur. The image capture system 500 may include an objective 502, a first mirror 504, a second mirror 506, a tube lens 508, and a camera 510. The objective 502 may include optical lenses and other optical components to provide a fixed magnification. The objective 502 may be selectable from a plurality of objectives to achieve different magnifications.

The tube lens 508 may include optical lenses and other optical components to focus the beams on the camera 510. In some examples, the tube lens 508 may include a fluidic focusing device to provide a variable focus shift based on the variable index of refraction of the fluid encapsulated therein. A charge may be applied by a controller (not shown) to the fluidic focusing device to change the index of refraction of the fluid in the fluidic focusing device, which in turn adjusts the focus of image capture system 500. The controller may adjust the charge applied to the fluidic focusing device in the tube lens 508 to rapidly change the focus of the final image, thus accounting for different contour variations of the substrate under inspection. For example, the fluidic focusing device may be provided as a tunable acoustic gradient lens. The fluidic focusing device may compensate focus blur in images caused by variations in the height of the substrate. In some examples, the tube lens 508 may be provided as a digital micromirror device. The digital micromirror device may be controlled by a controller to change the focus to compensate for the focus blur due to variations in the height of the substrate.

The camera 510 may be provided as an image sensor, such as a CMOS or CCD sensor. In some examples, the camera may be provided as an infrared sensor, such as InGaAs sensor. The camera 510 may be coupled to a processor including an image analysis module. The processor may process the images generated by the camera and analyze the images to detect defects. The processor may execute machine learning algorithms to detect defects in the images captured by the camera of portions of the substrate. In some examples, the camera 510 may include other optical components such as focusing lenses.

The first mirror 504 and the second mirror 506 may be provided between the objective 502 and the tube lens 508 in a periscope configuration to reduce motion blur. The first mirror 504 may be coupled to a motor, such as DC motor or piezo-electric motor, to rotate or dither the mirror based on the velocity of the stage to reduce motion blur by adjusting the beam deflection between the objective 502 and the tube lens 508. The first mirror may be provided as a small mirror, such as having a specification of 6 mm×35 mm×25 mm with a weight of about 14 grams. In some examples, the second mirror 506 may be positioned in stationary orientation to reflect light beams from the first mirror 504 to the tube lens 508. In some examples, the second mirror 506 may also be configured to rotate or dither so that the combination of the movement of the first mirror 504 and second mirror 506 may generate desired beam deflection. As described in further detail below, the first mirror 504 (and the second mirror 506 in some examples) may be provided as a digital micromirror device.

In some examples, the first mirror 504 can continuously rotate in one direction according to a predetermined angular velocity profile based on the speed of the stage. For example, the stage may be moving at a speed greater than 20 mm/sec. In some examples the stage may be moving at about 200 mm/sec.

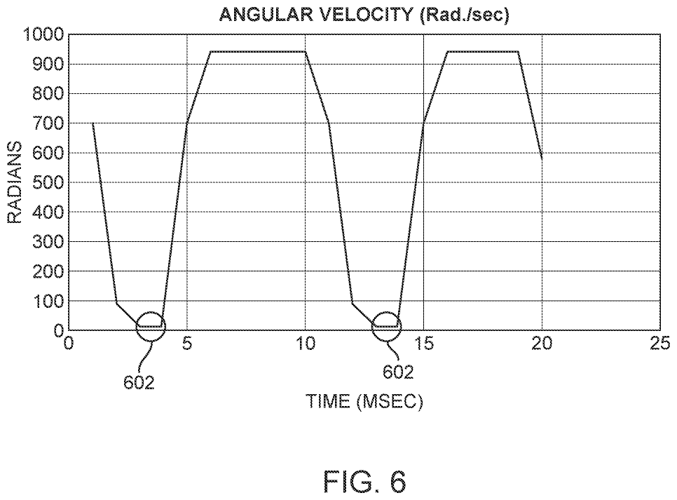

The first mirror 504 may be coupled to a motor, such as a DC motor, and an encoder to monitor the velocity of the first mirror 504. The motor may drive the first mirror 504 to rotate based on a predetermined angular velocity profile. FIG. 6 illustrates an example of a preset angular velocity profile for a rotating mirror. The first mirror 504 may be accelerated to its maximum angular speed (e.g., about 950 Rad./sec in this example) and then deaccelerated to a low and constant speed and then accelerated again to its maximum angular velocity and so on. During interval 602, the first mirror 504 rotates at a low and constant speed, which matches moving velocity of the stage. The rotating speed of the first mirror 504 in interval 602 is substantially lower than the rotating speed of the first mirror 504 during other time periods. When the velocity of the first mirror 504 reaches the low and constant speed at interval 602, the camera 510 may then capture an image of the portion of the substrate positioned below the image capture system. The duration of interval 602 may be of sufficient time to include the exposure time of the camera 510.

In some examples, the first mirror 504 may dither back and forth in a specified angle range across its equilibrium position according to a predetermined angular velocity profile based on the speed of the stage. For example, the stage may be moving at a speed greater than 20 mm/sec. In some examples the stage may be moving at about 200 mm/sec.

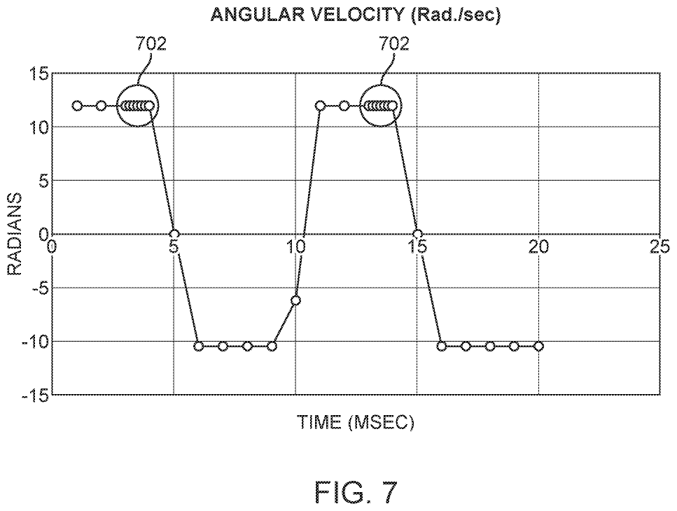

The first mirror 504 may be coupled to a motor, such as a DC motor or a piezo-electric motor, to move the first mirror 504 back and forth based on a predetermined angular velocity profile. FIG. 7 illustrates an example of a preset angular velocity profile for a dithering mirror. The first mirror 504 may be accelerated to its maximum angular speed (e.g., 12 Rad./sec in this example). The first mirror 504 may be kept at that speed for at least an interval 702. During the interval 702, the camera 510 may capture an image of the portion of the substrate positioned below the image capture system. The duration of interval 702 may be of sufficient time to include the exposure time of the camera 510. For example, the interval 702 may at least be 1 millisecond during which the velocity of the dithering mirror is controlled at the specified velocity (e.g., 12 Rad./sec in this example).

A piezo-electric motor may control the dithering of the first mirror 504 based on the angular velocity profile. In steady state, the dithering motion may be repeated at frequency cycle (e.g., 100 Hz). The frequency cycle can be adjustable.

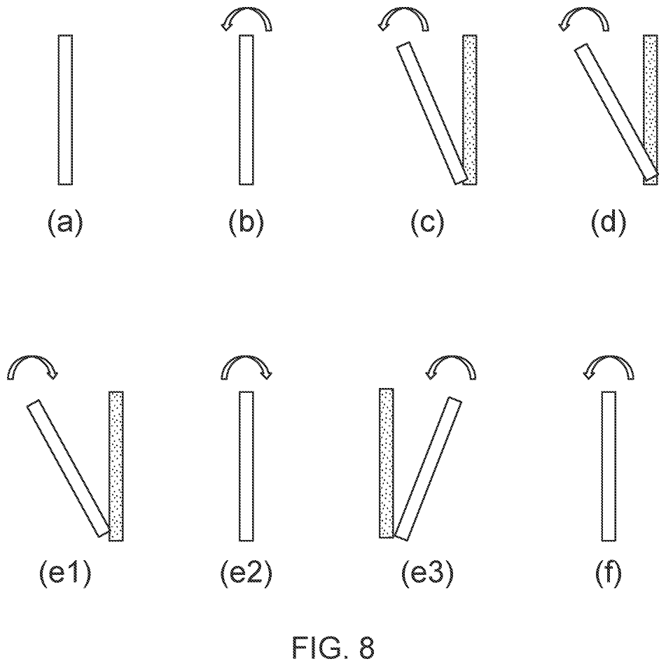

FIG. 8 illustrations an example of a motion profile for a dithering mirror. At step (a), the mirror may be stationary in its equilibrium position. The angular velocity ω is zero at this step. At step (b), after an initial start time (TO), the mirror may pass equilibrium with an angular velocity ω of non-zero. At step (c), the mirror may enter the interval (e.g., interval 702) for image capturing with a specified angular velocity (e.g., 12 Rad./sec) at time TD1, where TD1 represents the start of interval in the frequency cycle. At step (d), the mirror maintains the specified angular velocity for the specified interval duration time (e.g., 1 millisecond) ending at time TD2, where TD2 represents the end of the interval such that the interval duration is TD2-TD1.

At steps (e1), (e2), and (e3), the mirror may swing in the opposite direction and back. At step (f), the mirror may pass the equilibrium position with the same non-zero angular velocity as step (b). The dithering motion may then be repeated.

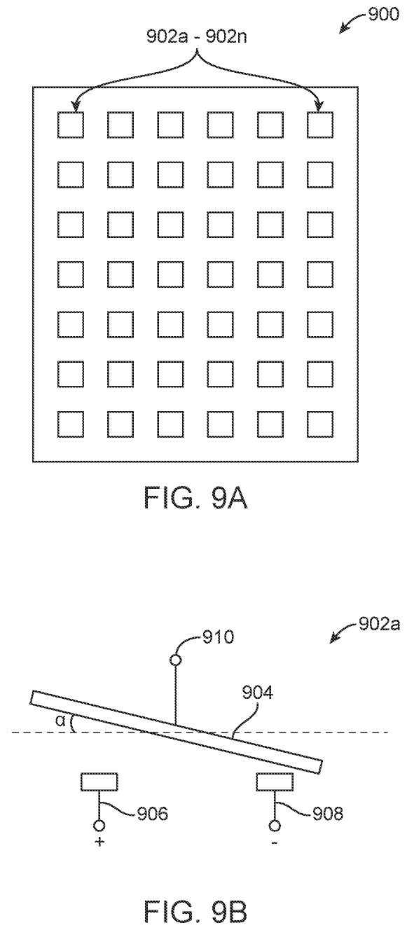

As mentioned above, the dithering mirror (e.g., first mirror 504) can be provided as a digital micromirror device to provide the dithering motion described herein. FIG. 9A illustrates example portions of a digital micromirror device 900 with dithering capabilities. The digital micromirror device 900 may include an array of micromirrors 902a-902n. The top surfaces of the array of micromirrors 902a-902n include a mirror surface. For example, the top surfaces of the array of micromirrors 902a-902n can be coated using a mirror material. The array of micromirrors 902a-902n can be formed on a silicon substrate, where each of micromirrors 902a-902n corresponds to a mirror pixel of the digital micromirror device 900. The micromirrors 902a-902n can be individually addressable to change the tilting angles of respective micromirrors 902a-902n. The micromirrors 902a-902n can be spaced close together so that the micromirrors effectively provide the image sensor with an image of the object or substrate.

FIG. 9B illustrates a schematic diagram of example portions a micromirror 902a. The micromirror 902a can include a top surface 904 provided using a mirror material. The top surface 904 can be coupled to a first electrode 906, a second electrode 908, and a power connection 910. The first electrode 906 and the second electrode 908 may be controlled to change the tilting angle of the top surface 904. For example, the first electrode 906 can be coupled to a positive voltage source, and the second electrode 908 can be coupled to a negative voltage source. A controller (not shown) can supply power to the first electrode and the second electrode 908 to change the tilting angle (a) of the top surface 904 of the micromirror 902a to provide the specified dithering angle. The power connection 910 may be used to supply power to the micromirror 902a.

The micromirrors 902a-902n may be individually controlled to change their respective tilting angles to provide the dithering profile for the micromirror device 900 to reduce motion blur as described above (e.g., FIGS. 7 and 8 and their descriptions). The time to change the tilting angles is relatively short because the digital micromirror device is a micro-electromechanical system (MEMS) and the size of the micromirrors 902a-902n is relatively small. As compared to a conventional mirror where the entire mirror (or at least the entire mirror surface) is moved to provide the dithering profile, the base of the digital micromirror device can remain stationary while the top surfaces of micromirrors move based on electrical control signals to provide the dithering profile.

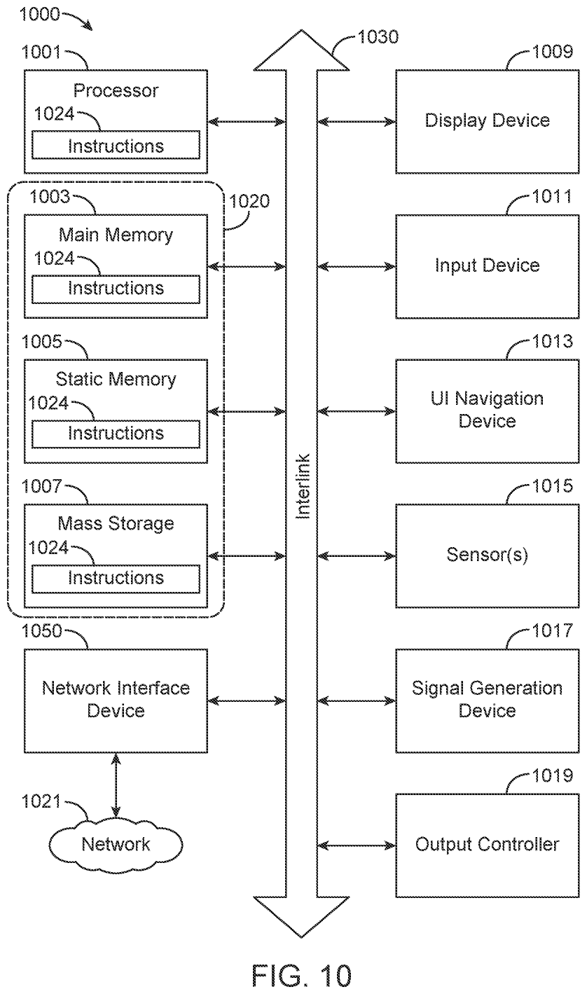

The techniques shown and described in this document can be performed using a portion or an entirety of an inspection system machine as shown in the figures described above or otherwise using a machine 1000 as discussed below in relation to FIG. 10. FIG. 10 illustrates a block diagram of an example comprising a machine 1000 upon which any one or more of the techniques (e.g., methodologies) discussed herein may be performed. In various examples, the machine 1000 may operate as a standalone device or may be connected (e.g., networked) to other machines.

In a networked deployment, the machine 1000 may operate in the capacity of a server machine, a client machine, or both in server-client network environments. In an example, the machine 1000 may act as a peer machine in peer-to-peer (P2P) (or other distributed) network environment. The machine 1000 may be a personal computer (PC), a tablet device, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware comprising the circuitry may include variably connected physical components (e.g., execution units, transistors, simple circuits, etc.) including a computer-readable medium physically modified (e.g., magnetically, electrically, such as via a change in physical state or transformation of another physical characteristic, etc.) to encode instructions of the specific operation. In connecting the physical components, the underlying electrical properties of a hardware constituent may be changed, for example, from an insulating characteristic to a conductive characteristic or vice versa. The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

The machine 1000 (e.g., computer system) may include a hardware-based processor 1001 (e.g., a central processing unit (CPU), a graphics processing unit (GPU), a hardware processor core, or any combination thereof), a main memory 1003 and a static memory 1005, some or all of which may communicate with each other via an interlink 1030 (e.g., a bus). The machine 1000 may further include a display device 1009, an input device 1011 (e.g., an alphanumeric keyboard), and a user interface (UI) navigation device 1013 (e.g., a mouse). In an example, the display device 1009, the input device 1011, and the UI navigation device 1013 may comprise at least portions of a touch screen display. The machine 1000 may additionally include a storage device 1020 (e.g., a drive unit), a signal generation device 1017 (e.g., a speaker), a network interface device 1050, and one or more sensors 1015, such as a global positioning system (GPS) sensor, compass, accelerometer, or other sensor. The machine 1000 may include an output controller 1019, such as a serial controller or interface (e.g., a universal serial bus (USB)), a parallel controller or interface, or other wired or wireless (e.g., infrared (IR) controllers or interfaces, near field communication (NFC), etc., coupled to communicate or control one or more peripheral devices (e.g., a printer, a card reader, etc.).

The storage device 1020 may include a machine readable medium on which is stored one or more sets of data structures or instructions 1024 (e.g., software or firmware) embodying or utilized by any one or more of the techniques or functions described herein. The instructions 1024 may also reside, completely or at least partially, within a main memory 1003, within a static memory 1005, within a mass storage device 1007, or within the hardware-based processor 1001 during execution thereof by the machine 1000. In an example, one or any combination of the hardware-based processor 1001, the main memory 1003, the static memory 1005, or the storage device 1020 may constitute machine readable media.

While the machine readable medium is considered as a single medium, the term “machine readable medium” may include a single medium or multiple media (e.g., a centralized or distributed database, and/or associated caches and servers) configured to store the one or more instructions 1024.

The term “machine readable medium” may include any medium that is capable of storing, encoding, or carrying instructions for execution by the machine 1000 and that cause the machine 1000 to perform any one or more of the techniques of the present disclosure, or that is capable of storing, encoding or carrying data structures used by or associated with such instructions. Non-limiting machine-readable medium examples may include solid-state memories, and optical and magnetic media. Accordingly, machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic or other phase-change or state-change memory circuits; magnetic disks, such as internal hard disks and removable disks; magneto-optical disks; and CD-ROM and DVD-ROM disks.

The instructions 1024 may further be transmitted or received over a communications network 1021 using a transmission medium via the network interface device 1050 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., the Institute of Electrical and Electronics Engineers (IEEE) 802.22 family of standards known as Wi-Fi®, the IEEE 802.26 family of standards known as WiMax®), the IEEE 802.27.4 family of standards, peer-to-peer (P2P) networks, among others. In an example, the network interface device 1050 may include one or more physical jacks (e.g., Ethernet, coaxial, or phone jacks) or one or more antennas to connect to the communications network 1021. In an example, the network interface device 1050 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1000, and includes digital or analog communications signals or other intangible medium to facilitate communication of such software.

### Various Notes

Each of the non-limiting aspects above can stand on its own or can be combined in various permutations or combinations with one or more of the other aspects or other subject matter described in this document.

The above detailed description includes references to the accompanying drawings, which form a part of the detailed description. The drawings show, by way of illustration, specific implementations in which the invention can be practiced. These implementations are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following aspects, the terms “including” and “comprising” are open-ended, that is, a system, device, article, composition, formulation, or process that includes elements in addition to those listed after such a term in an aspect are still deemed to fall within the scope of that aspect. Moreover, in the following aspects, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other implementations can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the aspects. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed implementation. Thus, the following aspects are hereby incorporated into the Detailed Description as examples or implementations, with each aspect standing on its own as a separate implementation, and it is contemplated that such implementations can be combined with each other in various combinations or permutations.

1. An image capture system to reduce motion blurring during semiconductor inspection, the image capture system comprising:
a stage to hold a substrate for inspection, wherein the stage is configured to move at a substantially constant speed during inspection;
a microscope objective positioned opposite the stage;
a mirror system to receive light beams from the microscope objective representative of the substrate and reflect the light beams to a tube lens, the mirror system including a mirror configured to move according to a preset angular velocity profile based on the speed of the stage, wherein the mirror system to move at a specified angular velocity for a defined time interval; and
an image sensor to generate an image of a portion of the substrate based on light beams received from the tube lens during the defined time interval.

2. The image capture system of claim 1, further comprising:
a piezo-electric motor coupled to the mirror to dither the mirror in a specified angle range across its equilibrium position based on the preset angular velocity profile.

3. The image capture system of claim 2, wherein the mirror dithers at a maximum angular speed during the defined time interval.

4. The image capture system of claim 1, wherein the angular velocity of the mirror reaches a substantially constant speed during the defined time interval, the substantially constant speed being lower than other time intervals in the angular velocity profile.

5. The image capture system of claim 1, wherein the mirror is a digital micromirror device.

6. The image capture system of claim 1, wherein the substantially constant speed is greater than 20 mm/sec.

7. The image capture system of claim 1, further comprising:
a processor to receive images from the image sensor to detect whether a defect is present in the substrate.

8. The image capture system of claim 1, wherein the tube lens includes a fluidic focusing device including a variable focus shift based on a variable index of refraction.

9. The image capture system of claim 8, wherein the fluidic focusing device includes a tunable acoustic gradient lens.

10. The image capture system of claim 1, wherein the tube lens includes a digital micromirror device.

11. A method for inspection of a substrate, the method comprising:
loading the substrate on a stage of an inspection system;
moving the stage at a substantially constant speed;
positioning the stage opposite a microscope objective;
moving a mirror to reflect light beams from the microscope objective representative of the substrate to a tube lens, the mirror moving according to a preset angular velocity profile based on the speed of the stage, wherein mirror moves at a specified angular velocity for a defined time interval; and
generating an image of a portion of the substrate based on light beams received from the tube lens during the defined time interval.

12. The method of claim 11, further comprising:
dithering the mirror in a specified angle range across its equilibrium position based on the preset angular velocity profile using a piezo-electric motor.

13. The method of claim 12, wherein the mirror dithers at a maximum angular speed during the defined time interval.

14. The method of claim 11, wherein the angular velocity of the mirror reaches a substantially constant speed during the defined time interval, the substantially constant speed being lower than other time intervals in the angular velocity profile.

15. The method of claim 11, wherein the mirror includes a digital micromirror device.

16. The method of claim 11, wherein the substantially constant speed is greater than 20 mm/sec.

17. The method of claim 11, wherein the tube lens includes a fluidic focusing device with a variable focus shift based on a variable index of refraction, wherein the fluidic focusing device includes a tunable acoustic gradient lens.

18. The method of claim 17, wherein the tube lens includes a digital micromirror device.

19. A system comprising:
a microscope objective positioned opposite a stage holding a substrate for inspection, wherein the stage is configured to move at a substantially constant speed during inspection;
a tube lens;
a mirror system positioned between the microscope objective and the tube lens, the mirror system to receive light beams from the microscope objective representative of the substrate and reflect the light beams to a tube lens, the mirror system including:
a first mirror to move according to a preset angular velocity profile based on the speed of the stage, wherein the first mirror to move at a specified angular velocity for a defined time interval, and
a second mirror positioned opposite the first mirror in a stationary orientation; and
a camera to generate an image of a portion of the substrate based on light beams received from the tube lens during the defined time interval.

20. The system of claim 19, further comprising:
a piezo-electric motor coupled to the mirror to dither the mirror in a specified angle range across its equilibrium position based on the preset angular velocity profile,
wherein the mirror dithers at a maximum angular speed during the defined time interval.

21. The system of claim 19, wherein the mirror includes a digital micromirror device.
